(19) United States
(12) Patent Application Publication
(10) Pub. No.: US 2008/0004920 A1
(43) Pub. Date: Jan. 3, 2008

(54) Airline management system generating routings in real-time

(75) Inventors: Thomas K. Bird, Eagan, MN (US); Steven P. Schuppenhauer, Eagan, MN (US); Robert T. Wilson, Minneapolis, MN (US)

Correspondence Address: UNISYS CORPORATION;MS 4773, PO BOX 64942, ST. PAUL, MN, 55164-0942, US

(73) Assignee: Unisys Corporation, St. Paul, MN (US)

(21) Appl. No.: 11/480,318

(22) Filed: Jun. 30, 2006

(51) Int. Cl. G06Q 10/00

(52) U.S. Cl. 705/5

(57) ABSTRACT

The invention is directed to a computer environment in which a management system for a transportation carrier, e.g., an airline carrier, generates routings in real-time. A routing module executing on a host computer system dynamically generates routings in real-time using a routings map as a mechanism for accessing up to date flight information stored in a central database. To reduce storage requirements in a multi-hosting environment, a single copy of flight information is maintained in the central database for each host airline and airline having a partnership agreement with a hosted airline. Consequently, as flight schedules and relationships between airlines change, possibly substantially continuously in a passenger environment, the management system may reduce the number of erroneous routings provided to an airline for use in booking passengers. Further, by reducing the number of erroneous routings, the number of requests submitted to the system may be reduced thereby increasing system performance.

### TECHNICAL FIELD

The invention relates to airline management systems and, more particularly, airline management systems that generate airline routings for aircrafts.

### BACKGROUND

Airline management systems enable a customer to view airline routes or routings that satisfy selected flight parameters before purchasing a flight ticket. For example, a customer may use an airline website to specify the type of trip, e.g., one-way, round trip, or multi-destination, origin and destination cities or airports, and departure and arrival dates and times. Alternatively, an agent acting on the customer's behalf may use the airline management system to search for routings that satisfy the selected flight parameters. In any case, when the search request is submitted, the airline management system generates a list of every routing that satisfies the request. When the customer selects one of the routings from the list, the airline management system attempts to book the customer for the flight segments associated with the selected route, i.e., purchase tickets for the customer.

In a passenger environment, however, flight schedules are changing as flights are delayed, cancelled, and added. Thus, the routings that are available for booking a passenger also change. Additionally, the partnership relationships between commercial passenger carriers may change. In particular, the flight schedules and relationships may change continuously as information changes. For example, at any given time, airline A (Northwest) may have a contractual relationship with airlines X (Sun Country), Y (American Airlines), and Z (United Airlines), such that airline A is able to book their passengers on flights provided by these other airlines, i.e., X-Z. Because of the contractual relationship of airline A with airlines X-Z, airline management system 12 uses the flight information for airlines A and X-Z to generate routings for airline A. As additional relationships are formed with airline A, or existing relationships are cancelled, terrinated, or expired, the flight segment combinations that are available for booking a potential traveler also change.

Because flight schedules and airline relationships change frequently, and possibly continuously, the airline management system sometimes generates invalid or erroneous routings when flight information is not up to date. For example, a customer may use an airline website to submit a search request for all possible routings from Minneapolis, Minnesota to Hong Kong, China on three separate carriers. However, during the time that it takes the airline management system to return a list of routings and the customer to select routings from the list, the selected routings may have been cancelled or otherwise become unavailable. Consequently, the airline management system returns an error when the customer attempts to purchase a ticket on the selected routings. When this occurs, the customer may continue to submit search requests in attempt to purchase a ticket.

### SUMMARY

In general, the invention is directed to a computer-implemented management system for a transportation carrier, such as an airline carrier, that generates routings in real-time. A routing module executing on a host computer system dynamically generates routings in real-time using a routings map as a mechanism for accessing up to date flight information stored in a central database. To reduce storage requirements in a multi-hosting environment, a single copy of flight information is maintained in the central database for each host airline and other airlines that have partnership agreements with the host airline. In this manner, as flight schedules and relationships between airlines change, possibly substantially continuously in a passenger environment, the management system may reduce the number of erroneous routings provided to an airline for use in booking passengers. Further, by reducing the number of erroneous routings, the number of requests submitted to the system may be reduced, thereby increasing system performance.

In operation, an airline management system maintains flight information for one or more host airlines and generates routings for use in booking passengers based on the stored flight information. The airline management system may generate routings in response to receiving a request, e.g., a schedule change request, a search request for possible flights that may be used to get a passenger from specified origin location to a destination, or an agreement information request to change an existing relationship between airlines. A request may be submitted by an agent, a module executing on the system, such as a routing module, flights module, or reaccommodation module, or an end user, such as a user that is using an airline's website. In response to a search request, the airline management system may return results, such as a list of routings that meet the search criteria, to an agent or a potential traveler. An agent or user may select one of the routes for use in potentially accommodating the traveler. In response to a schedule change request, the system may return results to the module that submitted the request or another module executing on the system.

In passenger environments, flight schedules are changing substantially continuously as flights are delayed, cancelled, and added. Additionally, the relationships between commercial passenger carriers are changing substantially continuously. Consequently, invalid or erroneous routings may be generated if flight information is not updated sufficiently frequently. Further, the volume of search requests received by an airline management system at any given time may be very large. When erroneous routings are generated, additional requests may be submitted until valid routings are returned, thereby decreasing system performance significantly. Thus, it is desirable to generate valid routings in response to schedule change and search requests.

As described herein, the airline management system includes a flights module and a routing module executing on a host computer system. The flights module receives requests, such as requests to change flight schedule information, requests to change partnership agreement information between airlines, and search requests, and invokes the routing module to dynamically generate routings in real-time based on the request. The interface between the flights module and the routing module provides a framework for the routing module to process information received from the flights module. In this manner, the interface ensures that the routing module generates routings using up to date information. By using up to date information to generate routings, the number of erroneous routings generated by the routings provided to the airline for booking passengers may be reduced. Reducing the number of erroneous routings may also promote increased system performance by limiting the number of requests submitted to the system.

The routing module does not use a typical brute force method to generate routings, i.e., search through pre-stored routings to select routings that satisfy the request. Rather, the routing module uses a mechanism, i.e., a routings map, to dynamically generate routings in real-time. The routing module creates the routings map, e.g., by transforming raw flight information into a machine readable format and uses the routings map quickly access flight information stored in a central database. The routings map may comprise an index structure similar to a database index that enables the routing module to quickly index into individual flights within the central database.

To reduce storage requirements in a multi-hosting environment, a single copy of flight information is maintained in and updated in the central database for each host airline and airline which has a partnership agreement with a host airline. Pending flight information, i.e., flight information that includes flights that may be cancelled, added or become involved in a schedule change, may also be maintained in the central database. Current, i.e., up to date, flight information used for generating routings, may be stored in a common partition of the database and pending flight information may be stored in a private partition that is not available or visible to any other airline in a multi-hosting environment. Pending flight information may be used to run “what-if” or hypothetical scenarios to determine how business will be affected if the pending changes are accepted. For example, the routing module may generate “intended” or test routings using the pending information for use in analyzing the affects on business. When pending information is accepted, the pending flight information is accepted into the central database, i.e., replaces the existing flight information stored in the common partition of the central database.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary computer environment in which an airline management system updates flight information in real-time in accordance with an embodiment of the invention.

FIG. 2 is a block diagram illustrating an exemplary embodiment of the airlines management system in further detail.

FIG. 3 is a block diagram illustrating exemplary modules and database systems of the airline management in further detail.

FIGS. 4-8 are flowcharts illustrating exemplary operation of the airline management system.

### DETAILED DESCRIPTION

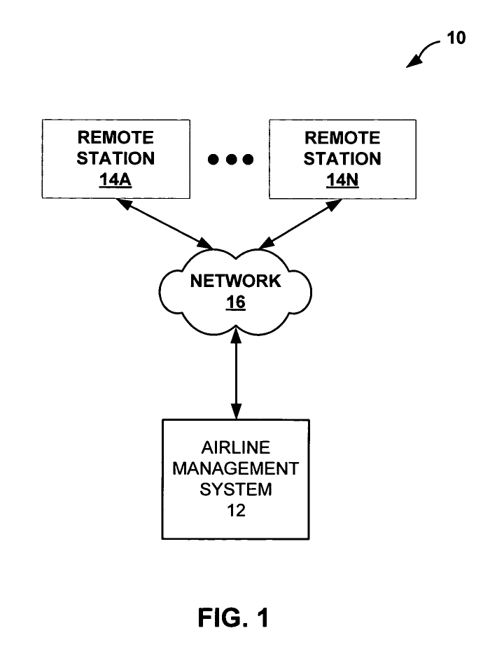

FIG. 1 is a block diagram illustrating an exemplary computing environment 10 in which airline management system 12 generates routings in real-time. As described herein, airline management system 12 includes a flights module that receives requests, such as requests to change flight schedule information, requests to change partnership agreement information between airlines, and booking requests, and invokes a routing module to generate routings in real-time based on the requests. The interface between the flights module and routing module provides a framework for updating flight information in real-time, i.e., maintaining flight information in an updated state. To reduce the storage requirements in a multi-hosting environment, a single copy of flight information is maintained in the central database for each host airline and other airlines that have partnership agreements with one or more of the host airlines. The routing module generates routings in real-time by using a routings map to quickly access flight information in the central database. Consequently, instead of generating routings by searching through pre-stored routings for routings that satisfy the request, the routing module dynamically generates routings in real-time in accordance with the request. In this manner, airline management system 12 may limit the number of requests by reducing the number of invalid or erroneous routings generated in response to a request. By reducing the number of requests, system performance may be increased.

As described herein, airline management system 12 provides a user interface with which a user residing at remote stations 14A-14N (“remote stations 14”) interacts to submit a request, such as a request to change flight schedule information, a request to change partnership agreement information between two or more airlines, or a search request for booking passengers on a flight. A user may be, for example, a customer using an airline's website, an agent, or a user acting on a customer's behalf. For example, a flight schedule change request and a partnership agreement information change request may typically be submitted by authorized personnel, i.e., an agent, and a search request may be submitted by a user, such as a customer or an agent acting on a customer's behalf.

In response to receiving a search request, airline management system 12 returns a list of potential flight segments or routings that may be used to transport a traveler from a specified origin location to a destination. To generate the routings, airline management system 12 uses as input the flight schedules for the various airlines that can be used to create the routings. In other words, airline management system 12 uses the flight schedules for the host airlines and any airlines which have a contractual agreement with the host airline to generate routings that satisfy the request. Based on these flight schedules, airline management system 12 determines the flight segment combinations or routings that can be used to transport a traveler from the origin to the destination. The routings are presented to the potential traveler, typically in an ordered manner, for use in booking a flight.

When airline management system 12 returns the list of routings for use in booking a passenger on a flight, the agent or system may select one of the routings from the returned results for use in potentially accommodating the traveler. A request is then made to attempt to purchase space for the flight segments included in the selected routing. If the space is available for the request, the space is purchased to satisfy the number of passengers associated with the request. Another request may then be issued to actually book the passengers on the purchased seats for the flight segments associated with the selected routing.

Alternatively, airline management system 12 may return a list of routings to a module executing on the system that is requesting the routings, such as a reaccommodation module that is requesting a list of routings to reaccommodate a traveler after a flight has been cancelled or delayed. In this case, the reaccommodation module may select one of the routings from the list to for use in booking the passenger on an alternative flight using business rules or other logic.

Remote stations 14 are generally associated with flight information stored by airline management system 12 and, thus, may be associated with flight information for one or more host airlines and airlines having a contractual agreement with the host airlines. In other words, airline management system 12 may be used to generate a list of routings for multiple airline carriers in accordance with a request submitted to the system.

Airline management system 12 presents the user interface as one or more graphical screens (not shown) that allow the user to submit a request and select one of the routings that is returned. The user may submit a request using any one of remote stations 14. In this manner, airline management system 12 assists the user in purchasing an airline ticket.

In a passenger environment, flight schedules are changing substantially continuously as flights are delayed, cancelled, and added. Additionally, the relationships between commercial passenger carriers are changing substantially continuously. For example, at any given time, airline A (Northwest) may have a contractual relationship with airlines X (Sun Country), Y (American Airlines), and Z (United Airlines), such that airline A is able to book their passengers on flights provided by these other airlines, i.e., X-Z. Because of the contractual relationship of airline A with airlines X-Z, airline management system 12 uses the flight information for airlines A and X-Z to generate routings for airline A. As additional relationships are formed with airline A, or existing relationships are cancelled, terminated, or expired, a different set of flight schedule information is used to generate valid routings for airline A.

Further, airline management system 12 may receive a large volume of search requests for booking passengers on flights at a given time. Thus, it is important to generate valid routings in response to a search request because invalid or erroneous routings result in additional requests being submitted until a set of valid routings is returned. Additional requests can substantially decrease system performance. For example, if flight information is not maintained in an up to date state, i.e., updated in real-time, one or more of the routings returned may include a flight segment that is no longer available, e.g., because a contractual relationship changed or the flight schedule was cancelled or delayed. Consequently, when a request is made to purchase space on a flight that is no longer available, an error will occur because the request cannot be fulfilled. Thus, a second request may be submitted and the process of booking the passenger on a selected flight segment is repeated. If the volume of requests is sufficiently high, presenting multiple requests to airline management system 12 to complete a single booking may decrease system performance substantially.

Airline management system 12, however, limits the number of invalid or erroneous routings generated in response to a request by updating flight information and generating routings in real-time. For example, when a flight schedule change request is received, airline management system 12 updates the appropriate flight schedule information. Similarly, when a partnership agreement change request is received, airline management system 12 updates the appropriate partnership agreement information. Updating flight or partnership agreement information may comprise replacing the currently stored information with the flight or partnership agreement information contained in the request, respectively. Updating flight or partnership agreement information may also comprise notifying other modules, such as the reaccommodations module, that might have to take some action based on the updated information. In this manner, airline management system 12 updates information in real-time.

To generate routings in real-time, airline management system 12 uses a mechanism, i.e., a routings map, to quickly access flight information stored in the central database and, thus, generate routings based on up to date information. The routings map is stored in memory and may comprise an index structure, such as a database index, that enables flight information to be quickly accessed within the database. Airline management system 12 builds the routings map each time flight information is updated to ensure that up to date flight information is used to generate routings. For example, the routings map may be built by transforming or processing flight information stored in the database into a machine readable format such as a database index. Thus, airline management system 12 does not search a database of pre-stored routings to generate routings that satisfy a search request. Rather, airline management system 12 dynamically generates routings by using a routings map that enables quick access to flight information stored in the database.

As previously described, flight schedules and partnership agreement information changes frequently, possibly substantially continuously. Although airline management system 12 updates flight information and generates routings in real-time, i.e., updates flight information and generates routings as requests are received, routings are not returned to a user substantially instantaneously. Rather, because of the number of the size of a typical flight database, which may contain millions of flight records, it may take airline management system 12 some time to generate routings in response to a request. For example, in response to a schedule change request, airline management system 12 may return a set of routings to a user in approximately less than a minute, approximately a minute, approximately one to three minutes, approximately three to five minutes, or more. Consequently, airline management system 12 may continue to receive requests, including flight schedule change requests, while updating flight information and generating routings in accordance a previously received request.

Airline management system 12 may track requests received while updating flight information and generating routings in real-time. The process of updating flight information and generating routings in real-time is may be referred to as the administrative process of airline management system 12. The process of tracking requests received while the administrative process is executing may be referred to as the maintenance process of airline management system 12. The administrative process may be invoked by a single request. However, more than one request may be received while the administrative process is executing. The maintenance process may track requests using a queue type method. Generally, airline management system 12 takes into account all of the requests it knows about when the administrative process is invoked. Thus, if more than one schedule change request was known when the administrative process was invoked, airline management system 12 updates the flight information and generates the routings in accordance with all of the schedule changes. In particular, the administrative process may update the information in accordance with all of the flight schedule changes followed by generating routings using the updated flight information.

It is important that the administrative and maintenance processes operate in a coordinated fashion. By operating in a coordinated fashion, it is likely that the administrative process will be invoked as soon as it completes because requests may be received substantially continuously. For this reason, it is important to update flight information in real-time and thereby limit the number of invalid routings that are generated.

Further, airline management system 12 stores a single copy of flight information in a central database for each host airline and airline with a partnership agreement with a host airline. In this manner, airline management system 12 reduces storage requirements, particularly in a multi-hosting environment. For example, in a multi-hosting environment, i.e., an environment in which airline management system 12 hosts multiple airlines, a single instance of airline management system 12 provides services for two or more separate airlines at the same time on one or more data processing systems. A multi-hosting environment may exist, for example, when an airline does not own its own reservation and departure control system, but contracts with a service provider to obtain these services. In a multi-hosting environment, airline management system 12 generates routings for each host airline.

For example, if an airline A has a contractual agreement to book passengers on flights provided by airlines A and X-Z, airline management system 12 uses flights provided by airlines A and X-Z to generate routings for airlines A. Thus, flight information for flights hosted by airlines A and X-Z is maintained in a current state, i.e., up to date state. Similarly, if airline B uses flights provided by airlines B, Y, and Z, flight information for flights hosted by airlines B, Y, and Z is maintained in an up to date state for generating routings for airline B. In this case, airline management system 12 uses flight information for airlines Y and Z to generate routings for airlines A and B. However, it is undesirable to maintain separate copies of flight information for airlines Y and Z, i.e., a first copy made available for airline A and a second copy made available to airline B. In other words, maintaining more than one copy of flight information requires additional storage space and also requires that the flight information is maintained in an updated state at each location, which increases processing demands.

Airline management system 12 also stores “pending” flight information, i.e., flight information that includes flights that may be cancelled, added, or become involved in a schedule change, in the central database. Pending flight information is stored in a private partition of the central database that is accessible only by the airline associated with the pending flight information. In other words, pending information is not visible to any other airline in a multi-hosting environment. Active flight information, i.e., flight information used to generate routings that may be used for booking passengers on a flight are stored in a common partition of the central database that is accessible by each airline.

Pending information is used by airline management system 12 to run “what-if” or test scenarios to determine how business will be affected if the pending changes are accepted. For example, incoming booking requests may be processed against pending information on a test basis only to determine potential consequences without actually making the bookings. As an example, airline management system 12 uses the pending information for the host airline and active flight information for partner airlines to run such test scenarios. In particular, airline management system 12 generates “intended” or test routings for use in analysis, i.e, determining potential consequences. For example, authorized personnel may review the intended routings and subsequently accept or reject the intended routings. When one of the changes from the pending information is accepted, the change is instituted in the common partition of the central database, i.e., the appropriate flight information is updated, for example, by replacing the existing flight information with the accepted flight information. Thus, airline management system 12 may generate routings in real-time thereby reducing the number of invalid routings generated in response to a search request. As a result, system performance may be increased because only a single request may be required to complete the booking process.

Each of the users associated with remote stations 14 typically accesses airline management system 12 via a network 16 using a remote computing device having suitable communication software such as a web browser. Network 16 may be any private or public network, and may include one or more Local Area Networks (LANs), Wide Area Networks (WANs) Wireless LANs or the like. Network 16 may include the Internet in some embodiments. Network 16 may also include one or more connected network devices (not shown), such as personal computers, laptop computers, handheld computers, workstations, servers, routers, switches, printers, fax machines, or other devices.

A user network may access airline management system 12 using a network-enabled computing communication device, such as a workstation, personal computer, laptop computer, or a handheld device. The communication device executes the communication software in order to communicate with airline management system 12.

For example, remote stations 14 may include a computing device located within a user's, e.g., a customer's, home or other location and the customer may remotely access airline management system 12 via the Internet. In another example, one or more remote stations may be located within hotels, travel agencies, or other locations. As another example, a user may access airline management system 12 via a self service terminal within an airport or other location.

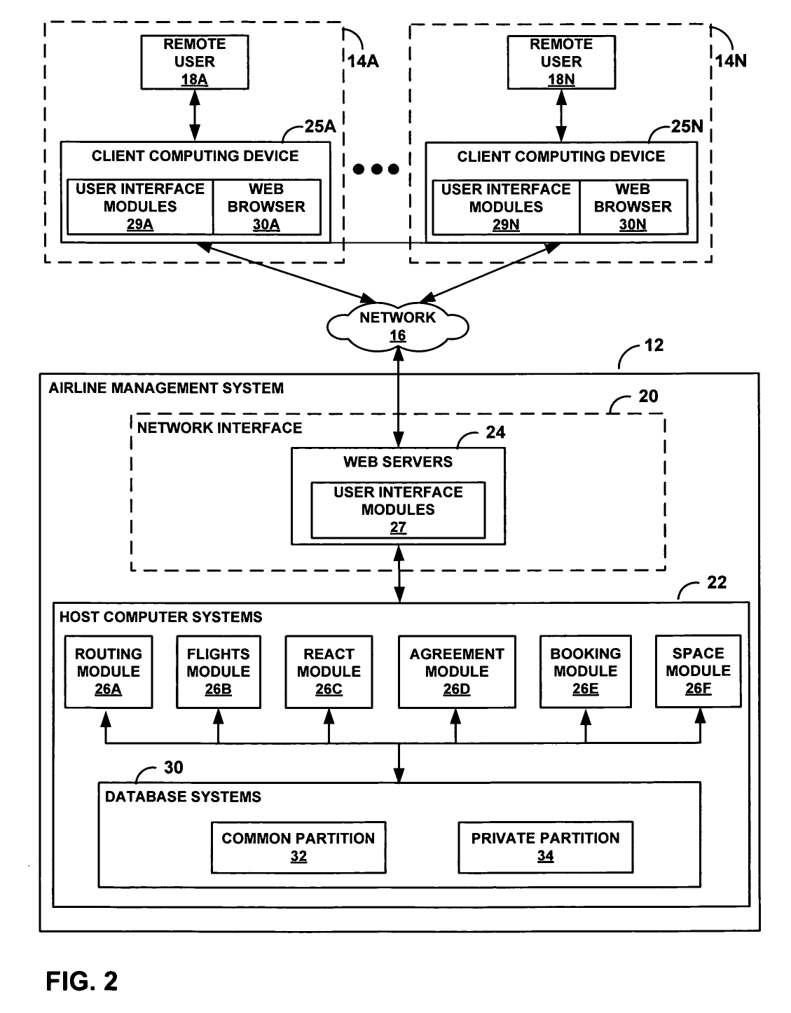

FIG. 2 is a block diagram illustrating an exemplary embodiment of airline management system 12 in further detail. In the exemplary embodiment, airline management system 12 includes one or more web servers 24 coupled to host computer systems 22. Web servers 24 provide a network interface 20 by which remote users 14 access host computer systems 22. Host computer systems 22 may be implemented as a distributed system including one or more servers executing a Unix, Windows®, or Linux operating system. Host computer systems 22 provide application servers to provide a computing platform for hosting airline management services for airline carriers and database systems 30 for storing information. Example database systems include database systems manufactured by Sun Microsystems, Hewlett Packard, Unisys Corporation, Microsoft Corporation, and Oracle Corporation.

Database systems 30 store flight information for host airlines and non-host airlines. In particular, database systems 30 store a single copy of flight information for each of the host airlines and airlines with a partnership agreement with a host airline. Flight information associated with a particular airline may be accessed by any other airline. For example, if two different airlines, e.g., airlines A and B, both utilize flights provided by airline C, the flight information associated with airline C may be accessed by both airlines A and B. By storing a single copy for each host airline, storage requirements may be reduced. In addition, processing demands may be reduced because flight information is updated in a single location.

In the illustrated example of FIG. 2, database systems 30 include a common partition 32 and a private partition 34. Active flight information is stored in common partition 32 and pending flight information is stored in private partition 34. As previously described, active information is used to generate routings used for booking passengers on flights. In particular, active flight information is used to build active routings maps, which are also stored in common partition 32, for generating routings. Pending flight information, however, is not used to make bookings. Instead, pending information is used for building intended routing maps which are also stored in private partition 34. Intended routing maps are used for running test or “what if” scenarios that are used to determine potential consequences without actually booking passengers on the flights. In other words, pending information is information that is associated with flights which may be cancelled, added, or may become involved in a schedule change. Accordingly, active flight information stored in common partition 32 is available to any host airline and pending flight information stored in private partition 34 is visible only to the host airline that is associated with the pending information.

In general, host computer systems 22 execute a number of modules that provide airline management services for airline carriers. In the illustrated example, host computer systems 22 comprise a routing module 26A, a flights module 26B, a reaccommodation (REACT) module 26C, an agreement module 26D, a booking module 26E, and a space module 26F. As previously described, airline management system 12 updates flight information and generates routings in real-time thereby reducing the number of invalid routings generated in response to a search request.

In operation, remote users 18A-N (“remote users 18”) may interact with flights module 26B to manage and control flight information, for example, by submitting a flight schedule change request or a search request. Flight information may, for example, be entered and maintained manually or through automated receipt of messages or files from a schedule planning system. Flights module 26B may support flight information using the standard schedules information manual (SSIM) format.

In any case, in response to receiving a request, flights module 26B invokes routing module 26A to update flight information and generate routings in accordance with the request. However, because flight schedules change substantially continuously and a large volume of search requests may be submitted at any given time, flights module 26B may receive requests substantially continuously. Consequently, flights module 26B may receive more than one request while routing module 26A generates routings in accordance with a previously received request. Thus, flights module 26B tracks requests received while routing module 26A is executing, e.g., using a queue or other mechanism. As a result, when flights module 26B invokes routing module 26A, flights module 26B may provide routing module 26A with all the requests received since routing module 26A was previously invoked. In other words, when flights module 26B invokes routing module 26A, it may not be in response to receiving a single response at a particular moment in time. Rather, flights module 26B may invoke routing module 26A such that routing module 26A operates substantially continuously.

The interface between flights module 26B and routing module 26A provides a framework that ensures routing module 26A generates routings in accordance with all of the requests in real-time using up to date flight information. For example, flights module 26B may invoke routing module 26A by sending a message to routing module 26A. The message may contain information associated with a single request. Thus, in the event that flights module 26A receives more than one message while routing module 26A is executing, flights module 26B may send multiple messages to routing module 26A at the same time, i.e., a message for each request.

For example, flights module 26B may send a message to routing module 26A that corresponds to a flight schedule change request. In this case, the message may contain flight information, such as the file type (host or non-host), airline associated with the flight information, type of information (active or intended), and location of a file, referred to herein as a “schedule change file”, containing the flight schedule changes. Routing module 26A may process the information contained in the message in accordance with the interface. For example, routing module 26A may first determine the type of information contained in the message, i.e., active or intended, in order to categorize any routings that may be generated as active or intended. If routing module 26A determines that the message includes active information, routing module 26A updates the appropriate flight information and subsequently generates routings using the updated information in accordance with the request.

Routing module 26A may update information in accordance with a flight schedule change request by replacing flight information currently stored in database system 30 with the flight information contained in a schedule change file. In particular, routing module 26A may process the message received from flights module 26B to determine the location of the schedule change file and subsequently merge the schedule change file with the specified host airline flight information stored in database systems 30. Routing module 26A may then generate routings based on the updated information in accordance with the request.

However, if the submitted request comprises a search request, however, the message sent by flights module 26B to invoke routing module 26A may include flight information such as the desired location and destination, travel dates, airline, number of passengers, and other information used to generate potential routings for transporting a traveler from the origin to the destination. Consequently, routing module 26A only generates routings in accordance with the request in this case, and does not update flight information.

As previously described, routing module 26A generates routings using a routings map. More specifically, routing module 26A includes a routings engine (not shown) which uses the routings map to generate routings. In particular, in response to receiving a search request, routing module 26A may generate routings using a routings map already stored in memory. However, in response to receiving a schedule change request, routing module 26A first builds a routings map using the updated flight information followed by generating routings using the routings map. Accordingly, routing module 26A builds a routings map whenever flight information is updated.

Routing module 26A may build a routings map by transforming flight information stored in database systems 30 into a machine readable format, such as a database index, which the routing engine can use to quickly access flight information. The routings map may be designated as an active routings map or an intended routings map. An active routings map may be used to generate routings used for booking passengers on flights. An intended routings map is not used to make bookings and is created using at least some pending information, i.e., information for flights that may be cancelled, delayed, added, or becoming involved in a schedule change. Rather, an intended routings map is used to run test scenarios to determine how business may be affected by the changes implemented in the intended routings map.

In any case, the routings engine uses the routing map to mathematically calculate all available routings provide by the host airlines from an origin location to a destination location. Importantly, unlike airline management systems that generate routings by searching through a database of pre-stored flight segments, the routings engine dynamically generates routings, i.e., generates routings in response to receiving a message from flights module 26B. Routing module 26A may also include selection logic for determining a best possible set of routings using, for example, business rules associated with the host airline. Accordingly, routing module 26A may present the routings in an ordered fashion to assist the customer in purchasing an airline ticket.

When routing module 26A has completed generating the routings, routing module 26A may send a message to flights module 26B indicating that the process is complete. Flights module 26B may then present the routings to remote users 18. When remote user 18, such as a customer or an agent acting on the customer's behalf, has selected a routing from the list of routings, flights module 26A submits a request to space module 26F, which manages the space of available flights. Space module 26F processes the request and attempts to purchase space for the flight segments that are included in the selected routing. If space is available on the selected flight segments, space module 26F purchases space for the number of passengers associated with the request and may send an acknowledgement message to flights module 26A. Flights module 26A may then submit yet another request to bookings module 26E which actually books the passengers on the flight segments associated with the selected routings.

React module 26C manages passenger related activities that are performed because a flight rescheduling event causes original transportation plans to be changed. Flights module 26A may send a message to react module 26C in response to receiving a flight schedule change request. In this case, react module 26C may process the message to determine how to reaccommodate the passengers affected by the flight schedule change. For example, react module 26C may submit a request to routing module 26A for alternate routings when a flight has been cancelled. In particular, react module 26C may submit a search request to flights module 26B which then sends a message to routing module 26A. Routing module 26A generates routings in accordance with the request and returns the routings to react module 26C for use in reaccommodating passengers affected by the schedule change.

Agreement module 26D manages partnership agreement information between commercial passenger airlines. An agent or other authorized personnel may interact with agreement module 26D to modify agreement information. Because existing relationships between airlines may be cancelled, terminated, or terminated, substantially continuously, routing module 26A may communicate with agreement module 26D to determine which airlines have a partnership with the host airline for booking passengers on flights provided by these other airlines. In particular, routing module 26A may communicate with agreement module 26D whenever routing module 26A builds a routings map.

Host computer system 22 may include other service modules (not shown) for booking passengers on routings generated by routing module 26A. Other example service modules include a ticketing module for managing ticket activity, a seating module for seat allocation, assignment, and reseating processes, an information module for managing automated information such as Visa requirements, ticketing rules, luggage policies and procedures, fare rules, promotions and the like, and a load control module for assisting airline load control agents to plan the distribution of payload aboard an aircraft.

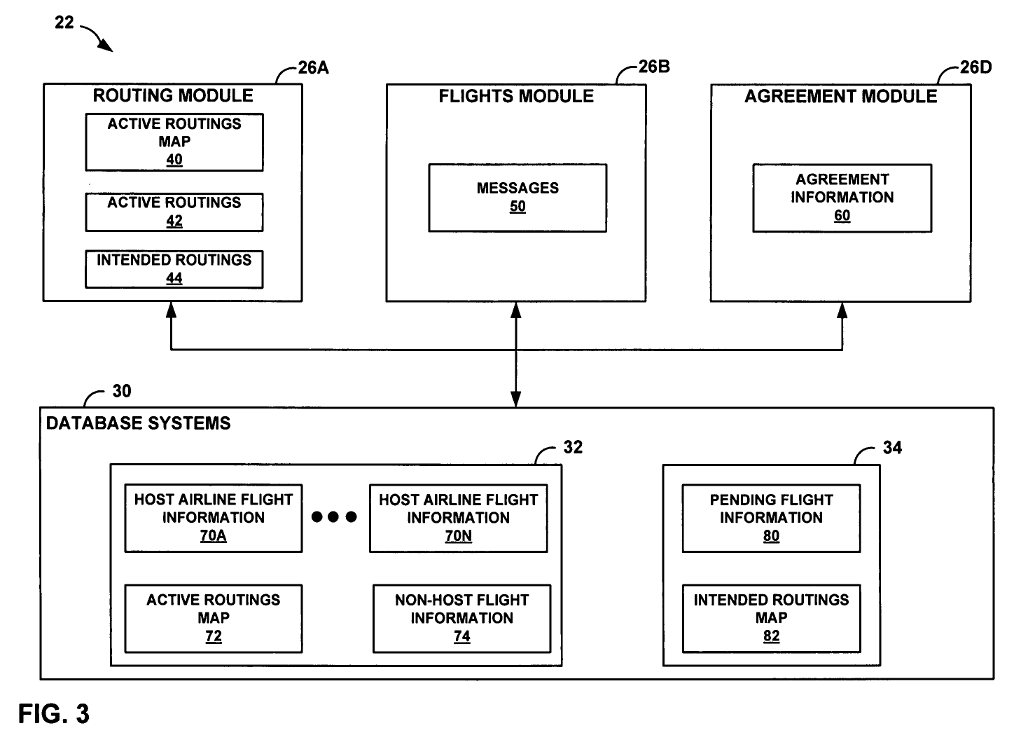

FIG. 3 is a block diagram illustrating routing module 26A, flights module 26B, agreement module 26D and database systems 32 within hosts systems 22 of airline management system 12 in further detail. The purpose of FIG. 3 is to illustrate in greater detail the relationship between flight information and the illustrated modules. Accordingly, FIG. 3 is merely exemplary and should not be considered limiting of the invention as more broadly described in this disclosure.

In the illustrated example of FIG. 3, database systems 30 include common partition 32 for storing active information and private partition 34 for storing pending or intended information. Common partition 32 stores a single copy of flight information for each host airline (host airline flight information 70A-N), an active routings map 72, and non-host flight information 74. As previously described, storing a single copy of flight information for each host airline and partner airline for the host airlines reduces storage requirements and processing demands.

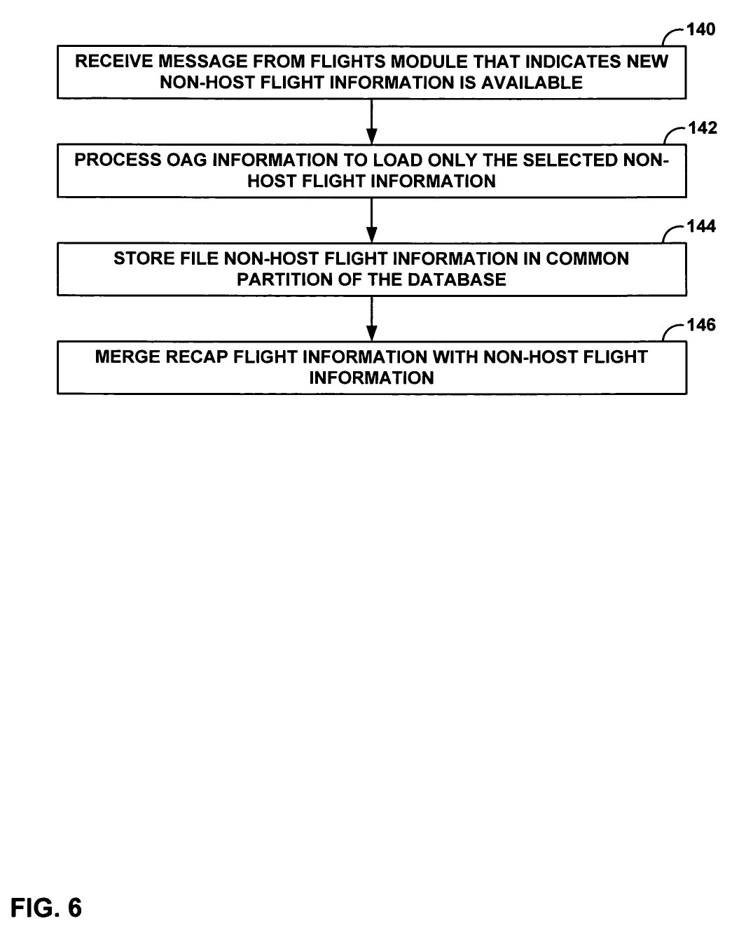

Non-host flight information 74 may contain flight information for selected non-host airlines instead of all the non-host airlines present in an official airline guide (OAG) file. In order to store flight information for only selected non-host airlines, airline management system 12 processes the OAG file, which may be stored in database systems 30 or an offline database that may be accessed by airline management system 12, to load flight information for the selected non-host airlines. The flowchart provided in FIG. 6 illustrates processing the OAG file in greater detail. Thus, non-host flight information 74 may comprise a smaller version of the OAG file that contains flight information for only the desired non-host airlines.

Routing module 26A builds active routings map 72 using host airline flight information 70A-N and non-host flight information 74. In particular, routing module 26A builds active routings map 72 whenever flight information is updated. As previously described, flights module 26B sends one or more messages 50 to routing module 26A in response to receiving requests submitted by a user or by one of the modules executing on host systems 22, such as REACT module 26D. For example, flights module 26B may send a message to routing module 26A for each request that it receives. Accordingly, each of messages 50 may contain flight information in accordance with the associated request. As an example, a message corresponding to a flight change request may include information such as, the file type (host or non-host), airline associated with the information, routings generation status (active or intended), and location of the file containing changes to the host flight information, i.e., the schedule change file.

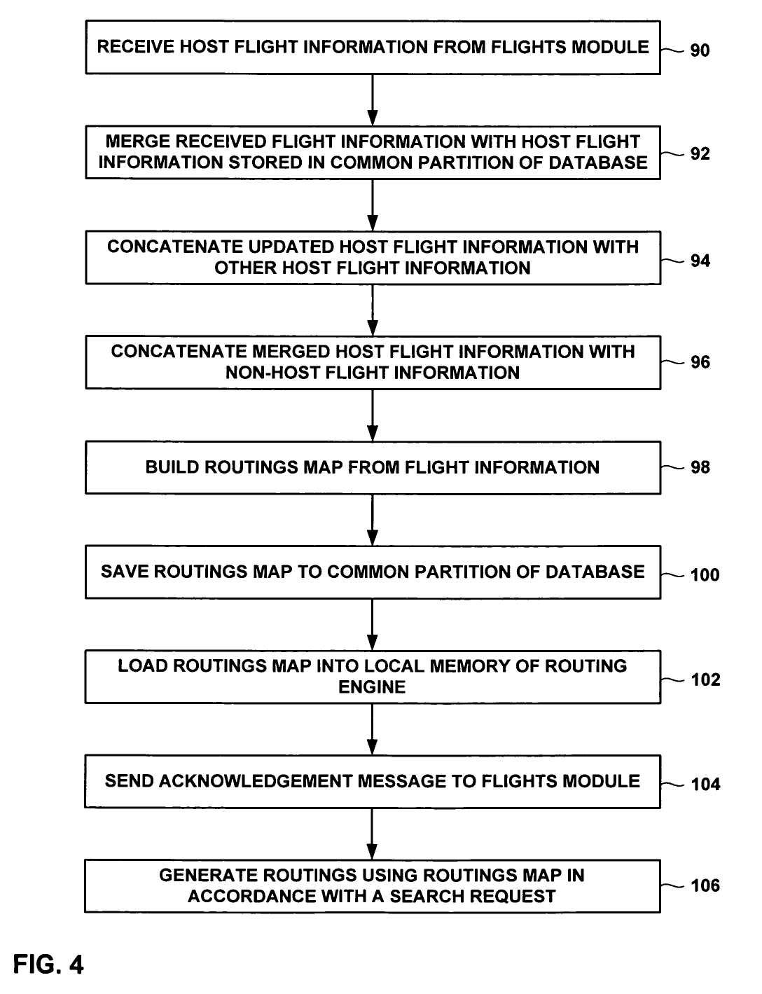

In order to build active routings map 72, routing module 26A first updates host airline flight information 70A-70N, e.g., by merging the updated flight information contained in the schedule change file with the flight information contained in the appropriate one of host airline flight information 70A-70N. This merged flight information is then concatenated with the other host airline flight information 70A-70N and non-host flight information. Routing module 26A may then build routings map 72 from this updated flight information. The flowchart illustrated in FIG. 4 describes the process of generating an active routings map in further detail.

For example, routing module 26A may build active routings map 72 by transforming the updated flight information into a machine readable format. The machine readable format may comprise a database index which may be used by a routings engine within routing module 26A to efficiently and quickly access host airline flight information 70A-70N and non-host flight information 74. Routing module 26A may load active routings map 72 into local memory for use by the routings engine. Accordingly, FIG. 3 illustrates active routings map 40 within routing module 26A. The routings engine uses active routings map 40 to dynamically generate a set of routings 42 in accordance with the received request. As previously described, the process of building active routings maps 72, 40 and generating a set of routings 42 may some time. For example, routing module 26A may return a set of routings 42 to a user in approximately less than a minute, approximately a minute, approximately three to five minutes, or more.

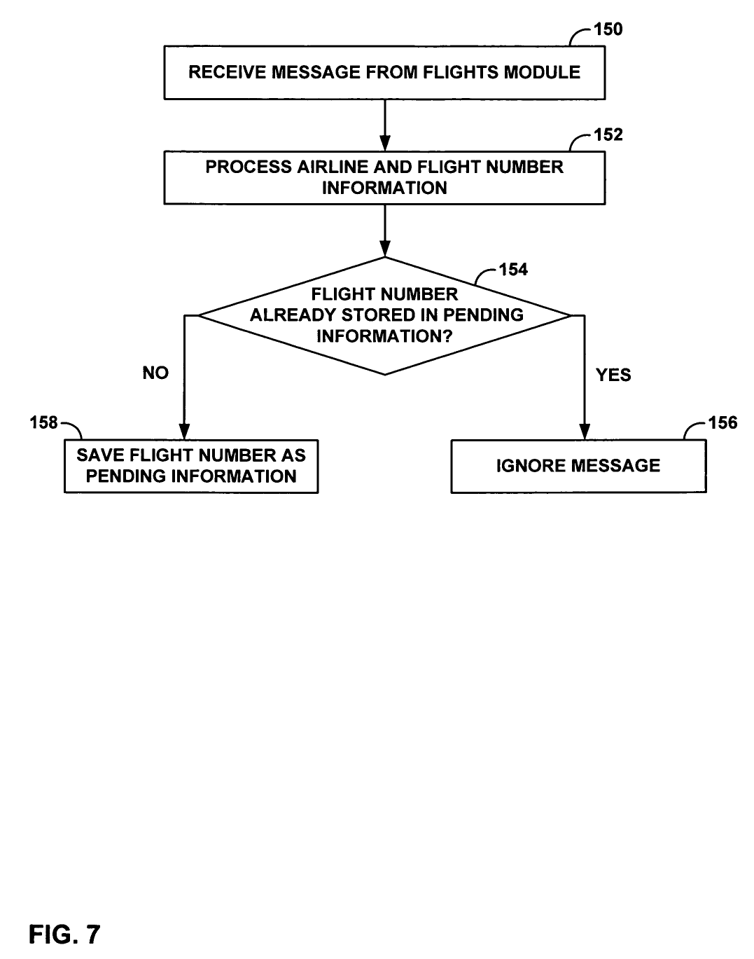

Importantly, flights module 26B continues to receive requests while routing module 26A generates active routings maps 72, 40 and set of routings 42. Flights module 26A sends messages 50 to routing module 26A which does not processes messages 50 until a new routings map is created. In this manner, routing module 26A generates routings in real-time in accordance with all of the requests received while generating the previous set of routings. FIG. 7 describes the process implemented by routing module 26A for processing messages 50 in greater detail.

As previously described, routing module 26A may also dynamically generate a set of intended routings 44 for use in analyzing the affects of potential changes to flight information before the changes are actually accepted, i.e., used in booking passengers. For example, routing module 26A may generate a set of intended routings 44 in response to receiving one of messages 50 from flights module 26B. In this case, the message received by routing module 26A contains flight information that is marked with an intended status. The information contained in the message, i.e., pending information 80, is stored in private partition 34 and contains potential updates to flight information for an airline.

In order to generate intended routings map 82, routing module 26A creates a copy of the flight information associated with the airline of interest and merges the copied flight information with pending flight information 80. This information is then concatenated with the flight information for other airlines that may be affected by the potential changes. The list of the other airlines may be obtained from agreement module 26D which stores airline agreement information 60. Airline agreement information 60 may contain information indicating the partnership agreements between airlines. Routing module 26A may then use this flight information to build intended routings map 82. Intended routings map 82 may then be used to generate a set of intended routings 44 that may be used to analyze the affects of the changes without actually booking passengers on flights. Upon reviewing intended routings 44, a user may decide to either accept or reject the potential changes.

When one of the changes from pending flight information 80 is accepted, the pending flight information is merged with the corresponding flight information stored in common partition 32. For example, if the pending information is associated with a host airline, the pending information is merged with the corresponding one of host airline flight information 70A-N. However, until the pending information is merged with active flight information stored in common partition 32, the pending flight information is not available to any other host or non-host airline which is no associated with the pending flight information.

FIG. 4 is a flowchart illustrating exemplary operation of airline management system 12 for generating routings in real-time using an active routings map. Initially, a user interface module 27 may present a user interface for receiving a schedule change request. Flights module 26B invokes routing module 26A by sending a message containing information associated with the schedule change request. The information contained in the message may include the file type (host or non-host), airline associated with the information, routings generation type (active or intended), and location of the schedule change file containing changes to the flight information in accordance with the request. In this case, the message routings generation type is active.

Routing module 26A processes the message to receive flight information from flights module 26A (90). In particular, routing module 26A records the airline associated with the flight information and the routings generation type, which is active in this case. After this information is recorded, routing module 26A merges the received flight information, i.e., the flight information updates, with flight information stored in common partition 32 of database systems 30 (92). The received flight information may be stored in a schedule change file which routing module 26A accesses. The location of the schedule change file is contained within the message received from flights module 26B. Routing module 26A may merge the received flight information with the existing flight information in the following manner. If a flight in the new information, i.e., updated flight information, is not found in the currently stored information, the new flight information is added. If a flight in the new information is found in the currently stored information, the stored information associated with that flight is discarded and the new flight information is added. If the new information indicates that a flight number is completely cancelled, all information stored for that flight is removed.

Next, routing module 26A concatenates the updated flight information with other host flight information (94) and subsequently concatenates the merged flight information with non-host flight information (96). Routing module 26A may then build an active routings map using the flight information (98). The routings map is saved on common partition 32 of database systems 30 (100) and loaded into local memory of a routings engine (102) executing in routing module 26A.

When the routings map has been created, routing module 26A may send an acknowledgement message to flights module 26B (104). The acknowledgement message serves to alert flights module 26B that routing module 26A is ready to generate routings. Routing module 26A may then generate routings using the routings map in accordance with a search request (106). In this manner, routing module 26A may dynamically generate routings in real-time thereby reducing the number of invalid routings returned in response to a search request.

After the routings map has been built, routing module 26A may dynamically generate routings using the routings map in accordance with any subsequently received search requests. However, the process described with respect to FIG. 4 may be repeated each time that a schedule change request is received because a new routings map is built every time that flight information is changed.

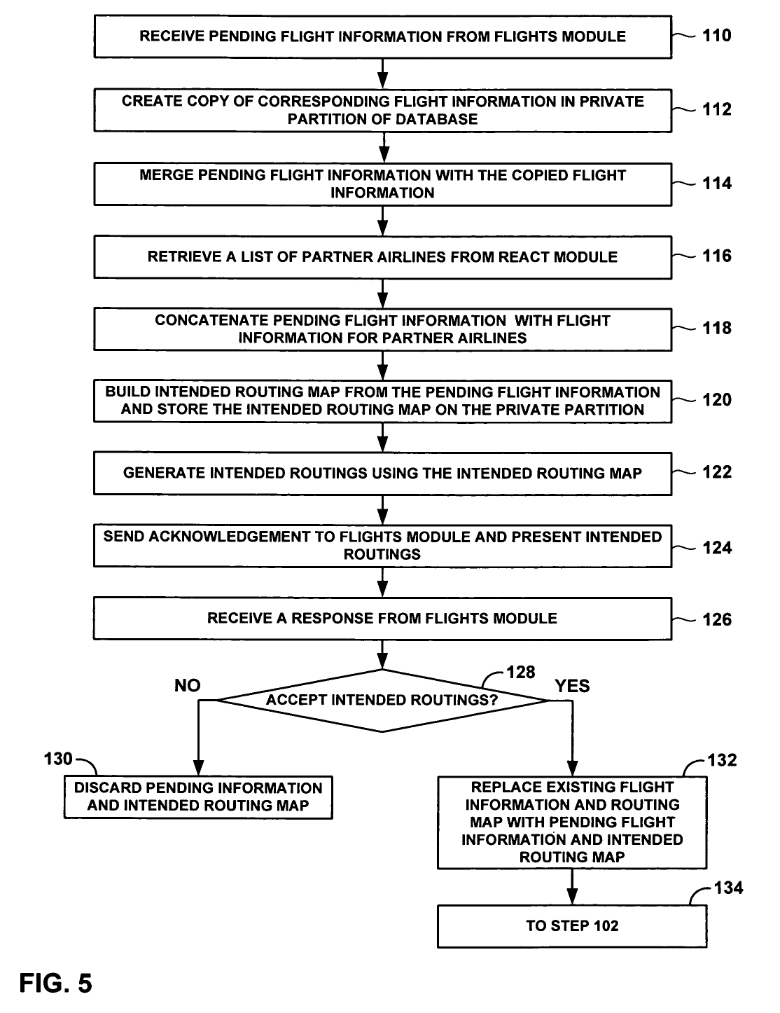

FIG. 5 is a flowchart illustrating exemplary operation of airline management system 12 for generating routings in real-time using an intended routings map. Initially, a user interface module 27 may present a user interface for receiving pending information, i.e., information associated with flights that may be cancelled, added, or may become involved in a schedule change. In this case, flights module 26B invokes routing module 26A by sending a message that contains the pending information. Again, the information contained in the message may include the file type (host or non-host), airline associated with the information, a flag or marker for indicating the intended status of the message, and location of the schedule change file containing changes to the flight information in accordance with the request.

Routing module 26A processes the message to receive the flight information, i.e., pending flight information, from flights module 26A ( 110). Next, routing module 26A creates a copy of the corresponding flight information in private partition 34 of database systems 30 (112). Routing module 26A may then merge the pending flight information with the copied flight information (114). The information may be merged in the following manner. If a flight in the new information, i.e., flight information updates, is not found in the copied information, the new flight information is added. If a flight in the new information is found in the copied information, the stored information associated with that flight is discarded and the new flight information is added. If the new information indicates that a flight number is completely cancelled, all information stored for that flight is removed from the copied information.

After the pending information is merged with the copied information, a list of partner airlines that may be affected by the potential changes is obtained from REACT module 26D (116). Routing module 26A concatenates the information that was merged together with the flight information associated with the airlines specified by REACT module 26D (118). In the event that the airlines obtained from REACT module 26D are non-host airlines, the flight information for the specified flights may be filtered from the file containing the non-host airline information.

Next, routing module 26A builds the intended routing map from the pending flight information and stores the intended routings map on private partition 120 of database systems 30. After the intended routings map has been built, routing module 26A may use the intended routings map to generate intended routings 122. Routing module 26A sends an acknowledgement, e.g., in the form of a message, to flights module 26B and presents the intended routings to a user. The acknowledgement message may alert flights module 26B that intended routings have been generated.

The intended routings may be used to determine how the potential changes will be affected by changes. For example, incoming booking requests may be processed against the intended routings on a test basis to determine how these changes will affect the airline's business without actually making bookings. If a user accepts the intended routings (12*) routing module 26A replaces the existing flight information and active routing map stored in common partition 32 with the merged pending flight information and intended routings map (132). Since the intended routings map has been accepted as an active routings map in this case, the airline management system 12 continues operating in accordance with step 102 of FIG. 4 (134). However, if a user does not accept intended routings, airline management system 12 discards the pending information and intended routings map stored in private partition 34 (136).

FIG. 6 is a flowchart illustrating operation of flight management system 12 for processing non-host flight information. In general, airline management system 12 processes non-host flight information in accordance with the steps illustrated in FIG. 6 after flights module 26B completes processing OAG information. Initially, routing module 26A receives a message from flights module 26B that indicates new non-host host flight information is available (140). The message may contain the location of the non-host flight information and the location of recap information for airlines not loaded via the OAG Flights module 26B may not pre-process the OAG file. Thus, routing module 26A may receive the OAG file in its original form as received from the OAG

Routing module 26A processes the OAG information to load only the selected non-host flight information (142). In particular, the actual OAG file received from the OAG may contain flight information for all of the airlines, i.e., the host airline, partner host airlines, and various non-host airlines. As the host and associated host airline schedule information is updated in real-time, uses the flight information for host and associated host airlines from central database systems 30. In other words, the host and associated host flight information present in the actual OAG file is not used.

The host airline may choose to load flight information for selected non-host airlines instead of loading flight information for all of the non-host airlines present in the OAG file. In some embodiments, airline management system 12 may include a system parameter than allows an airline to create a list of non-host airlines. The system parameter may be set to include or exclude the flight information for select on-host airlines. For example, if the system parameter is set to “include”, routing module 26A removes the flight information from the OAG for any non-host airline that is not amongst the list of non-host airlines. If the system parameter is set to “exclude”, routing module 26A removes the flight information from the OAG file. This process creates a smaller version of the OAG file that contains flight information for only the desired non-host airlines.

The service provider may choose not to load flight information for a non-host airline from the OAG file, but may process flight information for that airline via flights module 26B. However, routing module 26A may not process flight information of a non-host airline sent by flights module 26B unless it can find type 2 and type 5 records for the airline in the smaller OAG file, i.e., the OAG file created using the above described process. As a result during the OAG load process, routing module 26A may load only the type 2 (carrier) and type 5 (trailer) record for a non-host airline that has a contractual agreement with the host airline but is not included in the OAG load process. This will ensure that routing module 26A does not load the flight information of the non-host airline from OAG file, but processes flight information for the non-host airline when sent by flights module 26B.

This new file, i.e., the smaller version of the OAG file, is stored in common partition 32 of database systems 30 (144). With reference to FIG. 3, this process may be used to create non-host flight information 74. Next, the recap information is merged with the new OAG or non-host information (146). In particular, all new OAG information not modified by the recap information is retained. For example, the information may be merged in the following manner. If a flight in the recap information is not found in the new OAG information, the recap information is added. If a flight in the recap information is found in the new OAG information, all periods for the flight are removed and the recap information is added. If the recap indicates that a flight number is completely cancelled, all new OAG information stored for the flight is removed.

FIG. 7 is a flowchart illustrating operation of airline management system 12 for receiving messages from flights module 26B. In general, airline management system 12 processes messages as they are received from flights module 26B. As previously described, messages may be received while routing module 26A generates routings in accordance with previously received messages. Thus, accumulated messages are not processed until routing module 26A completes processing the previously received messages.

Initially, routing module 26A receives a message from flights module 26B (150). The message may comprise a standard schedule message (SSM) that may be used to update flight information. Routing module 26A processes the airline and flight number information contained in the received message (152). If the flight number is already stored (154), the message is ignored (156). However, if the flight number is not already stored, the flight number is stored as pending information (158), e.g., in private partition of database systems 30.

The steps of FIG. 7 are repeated for each message that is received until routing module 26A has completed processing the previously accumulated messages.

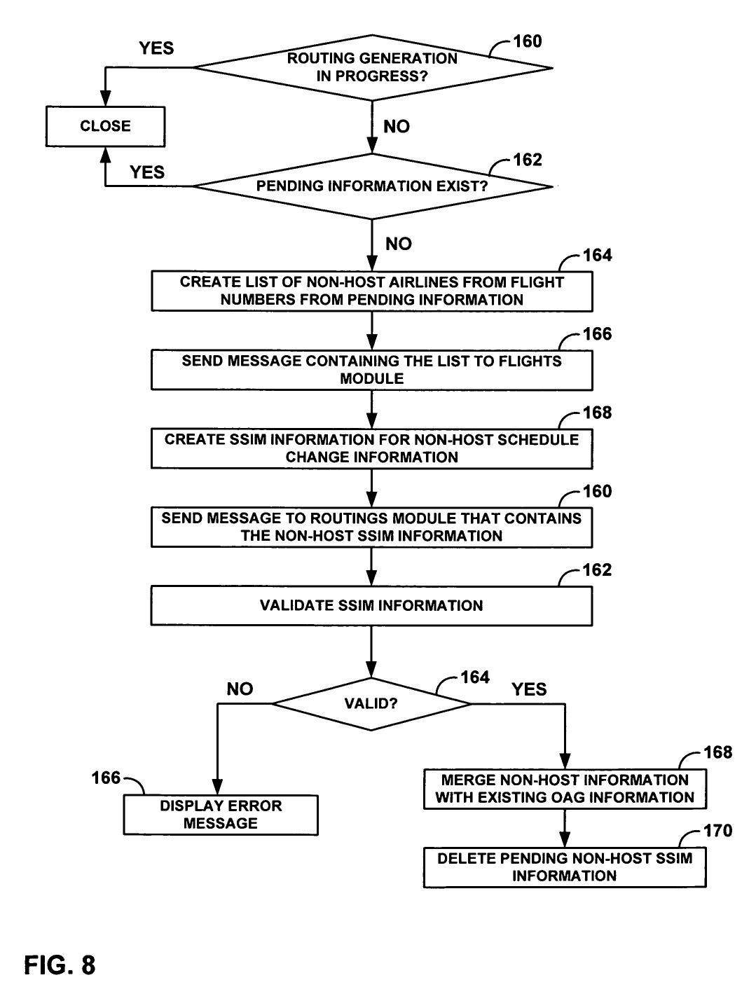

FIG. 8 is a flowchart illustrating exemplary operation of airline management system 12 for processing pending non-host information. In general, airline management system 12 periodically invokes this process to check for pending information. The super host of airline management system 12 may define the period.

When routing generation (160) for new OAG information is in progress or if no pending exists (162), this process closes (172). Otherwise, airline management system 12 creates a list of all non-host airlines and flight numbers that are saved as pending information (164) and sends a message containing the list to flights module 26B (166). Flights module 26B creates flight information, e.g., SSIM flight information, for the non-host schedule change information contained in the list (168) and sends a message to routing module 26A that contains the non-host schedule change information (170). Routing module 26A validates the schedule change information (172). For example, routing module 26A may validate (174) that information for each of the requested flights is contained in non-host flight information, e.g., non-host flight information 74 in FIG. 3, and that non-host flight information 74, does not contain any information for any flight which were not requested. If routing module 26A finds the schedule change information to be invalid, an error message may be displayed (176). However, if validation is successful airline management system 12 merges the non-host schedule change information with the currently stored OAG information (178). Flight information currently stored in OAG information, i.e., non-host flight information 74, is retained if it is not modified by the non-host schedule change information. The merge may be performed in the following manner. If a pending flight is not found in the stored OAG information, the pending information is added. If a pending flight is found in the stored OAG information, all information for that flight is removed and the pending flight information is added. If the pending information indicates that a flight is completely cancelled, all information stored for that flight is removed.

After non-host schedule information has been merged with active information, i.e., included into common partition 32, all pending non-host flight information is deleted (179). Airline management system 12 may then proceed to generate an active routings map using the updated information. For example, airline management system 12 may continue operation in accordance with step 96 of FIG. 4.

The techniques described herein may be implemented in hardware, software, firmware, or any combination thereof. If implemented in software, the techniques may be directed to a computer-readable medium comprising instructions, that when executed in one or more computers, causes the computer(s) to perform the techniques described herein. In that case, the computer readable medium may comprise any volatile or non-volatile storage medium, such as random access memory (RAM), read-only memory (ROM), non-volatile random access memory (NVRAM), electrically erasable programmable read-only memory (EEPROM), FLASH memory, and the like.

The instructions may be stored on memory and executed in a processor in order to carry out one or more of the techniques described herein. In other cases, the units or modules described herein may be implemented as a microprocessor, one or more application specific integrated circuits (ASICs), one or more field programmable gate arrays (FPGAs), or some other hardware-software combination.

Various embodiments of the invention have been described. Although the embodiments are described in terms of an airline for exemplary purposes, the techniques of the invention may be applied to improve the efficiency of generating a list of routings in other transportation industries. These and other embodiments are within the scope of the following claims.

1. A method comprising:
maintaining a central database of an airline management system to store flight information for one or more airlines;
receiving a request that contains flight information for one of the airlines;
executing a routing module on a host computer system of the airline management system, in response the request, to generate one or more routings in real-time in accordance with the request.

2. The method of claim 1, wherein the request comprises a schedule change request and maintaining the central database comprises executing the routing module to access the central database in response to receiving the schedule change request to update flight schedule information in real-time in accordance with the schedule change request.

3. The method of claim 2, further comprising executing the routing module to build a routing map that provides an index for accessing the flight information stored in the central database and generate the one or more routings using the routings map, wherein the routing module builds the routing map after updating the flight information.

4. The method of claim 1, wherein maintaining the central database comprises maintaining a single copy of flight information for each of the host airlines

5. The method of claim 1, wherein executing the routing module to generate the one or more routings comprises executing the routing module to build a routings map that provides an index for accessing the flight information stored in the central database and generate the one or more routings using the routings map.

6. The method of claim 1, wherein maintaining the central database comprises maintaining a common partition of the central database that stores active flight information for the airlines and a private partition of the central database that stores pending information for one or more of the airlines, wherein the pending information is available to only the associated airline.

7. The method of claim 1, wherein the request comprises one of a schedule change request having an active status and a schedule change request having an intended status, and wherein executing the routing module further comprises:
executing the routing module to determine the status of the request,
when the status of the schedule change request is determined to be active, executing the routing module to access the central database to update the flight information and generate one or more routings in real-time in accordance with the schedule change request, and
when the status of the schedule change request is determined to be intended, executing the routing module to access the central database to copy flight information from the central database to a private partition of the central database in accordance with the schedule change request, merge the copied flight information with flight information contained in the schedule change request, and generate one or more intended routings in real-time based on the flight information stored in the private partition, wherein the private partition is accessible only by the airline associated with the flight information contained in the schedule change request.

8. The method of claim 7, further comprising presenting a network user interface to display the intended routings and receive input for one of accepting and rejecting the intended routings and, in response to receiving the input, executing the routing module to update the flight information stored in the central database in accordance with the schedule change request when the intended routings are accepted, and executing the routing module to delete the intended routings and flight information stored in the private partition of the central databases when the intended routings are rejected.

9. The method of claim 1, wherein receiving a request comprises receiving a first request and executing the routing module in response to receiving the first request to generate one or more routings in real-time in accordance with the first request, and receiving a second request while the routing module generates the routings in accordance with the first request and executing the routing module to generate one or more routings in real-time in accordance with the second request, wherein executing the routing module to generate the routings in accordance with the second request comprises executing the routing module after generating the routings in accordance with the first request.

10. An airline management system comprising:
one or more host computer systems that maintain a central database that stores flight information for one or more airlines;
a routing module executing on at least one of the host computer systems;
a flights module executing on each of the host computer that receives one or more requests,
wherein the flights module invokes the routing module in response to receiving the requests to generate one or more routings in real-time in accordance with the requests.

11. The system of claim 10, wherein the flights module receives a schedule change request and invokes the routing module in response to receiving the schedule change request to update flight schedule information in real-time in accordance with the schedule change request.

12. The system of claim 10, wherein the host computer systems maintain the central database to store a single copy of flight information for each of the host airlines.

13. The system of claim 10, wherein the flights module receives a schedule change request, and wherein the routing module builds a routing map that provides an index for accessing the flight information stored in the central database and uses the routing map to access the central database to generate the one or more routings in real-time in accordance with the request.

14. The system of claim 10, wherein the central database comprises a common partition that stores active flight information for the airlines and a private partition that stores pending information for one or more of the airlines, and wherein the host computer system provide access to pending information to only the associated airline.

15. The system of claim 10, further comprising:
a computer coupled to at least one of the host computer systems; and
a user interface module operating on the computer system to present a user interface that receives flight information for at least one of the airlines from a user and submits one of a search request and a schedule request to the flights module in accordance with received flight information.

16. The system of claim 10, wherein the flights module receives one of a schedule change request having an active status and a schedule change request having an intended status and invokes the routing module to determine the status of the request, and
wherein the routing module determines the status of the schedule change request to be active and generates one or more routings in real-time in accordance with the active schedule change request, and
wherein the routing module determines the status of the schedule change request to be intended and accesses the central database to create a copy of flight information in a private partition of the central database in accordance with the schedule change request, merges the copy of the flight information with the flight information contained in the schedule change request, and generates one or more intended routings in real-time based on the flight information stored in the private partition.

17. The system of claim 16, further comprising:
a computer coupled to at least one of the host computer systems; and
a user interface module operating on the computer system to present a user interface that displays the intended routings and receives input for accepting or rejecting the intended routings, and
wherein the routing module updates the flight information stored in the central database in accordance with schedule change request when the intended routings are accepted, and deletes the intended routings and flight information stored in the private partition when the intended routings are rejected.

18. The system of claim 10, wherein the flights module receives a first request and invokes the routing module to generate one or more routings in real-time in accordance with the first request and receives a second request while the routing module generates the routings in accordance with the first request and invokes the routing module to generate one or more routings in real-time in accordance with the second request, wherein the routing module generates the routings in accordance with the second request after generating the routings in accordance with first request.

19. An airline management system comprising:
means for maintaining a central database of the airline management system to store flight information for one or more airlines;
means for receiving a request that contains flight information for one of the airlines;
and means for executing a routing module on a host computer system of the airline management system, in response the request, to generate one or more routings in real-time in accordance with the request.

20. The system of claim 19, wherein the means for executing the routing module to generate the one or more routings comprise means for executing the routing module to build a routings map that provides an index for accessing the flight information stored in the central database and generate the one or more routings using the routings map.
